(19) United States
(12) Patent Application Publication
(10) Pub. No.: US 2007/0220375 A1
(43) Pub. Date: Sep. 20, 2007

(54) Methods and apparatus for a software process monitor

(75) Inventor: Tomer Baz, San Jose, CA (US)

Correspondence Address: INGRASSIA FISHER & LORENZ, P.C., 7150 E. CAMELBACK, STE. 325, SCOTTSDALE, AZ, 85251, US

(73) Assignee: Symbol Technologies, Inc.

(21) Appl. No.: 11/362,470

(22) Filed: Feb. 24, 2006

(51) Int. Cl. G06F 11/00

(52) U.S. Cl. 714/55

(57) ABSTRACT

A process monitor is configured to monitor the state of a number of software processes through the use of regular “heartbeat” messages sent by those processes. In the event that expected heartbeats are not received, or are received at unexpected intervals, the process monitor decides what action to take—e.g., whether that process should be restarted, killed, terminated, or the like. The heartbeats may distinguish, for example, between processes that are no longer running, and processes that are running but not functioning properly.

### TECHNICAL FIELD

The present invention relates generally to wireless local area networks (WLANs) and, more particularly, to software process monitor modules used in connection with a WLAN.

### BACKGROUND

In recent years, there has been a dramatic increase in demand for mobile connectivity solutions utilizing various wireless components and wireless local area networks (WLANs). This generally involves the use of wireless access points that communicate with mobile devices using one or more RF channels.

Due to the large number of components and the high-complexity of software systems running in a network environment, there is a great risk of downtime due to one or more software processes crashing or operating improperly. When such processes do fail, significant personnel and computer resources are needed to bring the system back up. Often, an operator must manually restart the entire system.

As an operator is not always available on-site, it is not uncommon for computer networks to experience extended and unnecessary down-time while waiting for the operator to troubleshoot and remedy the error.

Accordingly, it is desirable to provide systems and methods for automatically monitoring and addressing software errors as they occur in a network. Furthermore, other desirable features and characteristics of the present invention will become apparent from the subsequent detailed description and the appended claims, taken in conjunction with the accompanying drawings and the foregoing technical field and background.

### BRIEF SUMMARY

In accordance with one embodiment of the present invention, a process monitor is configured to monitor the state of a number of software processes through the use of regular “heartbeat” messages sent by those processes. In the event that expected heartbeats are not received, or are received at unexpected intervals, the process monitor decides what action to take—e.g., whether that process should be restarted, killed, terminated, or the like. The heartbeats may distinguish, for example, between processes that are no longer running, and processes that are running but not functioning properly.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a WLAN topology useful in describing the present invention;

FIG. 2 is a decision tree for a non-responsive process in accordance with the present invention;

FIG. 3 is process monitoring state machine in accordance with the present invention;

FIG. 4 is a system monitoring state machine in accordance with one aspect of the present invention;

FIG. 5 is a schematic overview of a process monitoring system;

FIG. 6 is a state machine in accordance with another aspect of the present invention, depicting normal process startup use case;

FIG. 7 is a state machine in accordance with another aspect of the present invention, depicting a process crash use case;

FIG. 8 is a state machine in accordance with another aspect of the present invention, depicting a use case involving a process with greater than the maximum allowable number of restarts;

FIG. 9 is a state machine in accordance with another aspect of the present invention, depicting a use case involving the process monitor starting after a crash;

FIG. 10 is a state machine in accordance with another aspect of the present invention, depicting a use case involving a process stuck and not responding to a “quit” signal;

FIG. 11 is a state machine in accordance with another aspect of the present invention, depicting a use case wherein a process is stuck and is responding to a “quit” signal;

FIG. 12 is a state machine in accordance with another aspect of the present invention, depicting a use case wherein a stopped process is restarted;

FIG. 13 is a state machine in accordance with another aspect of the present invention, depicting a use case wherein a process exits gracefully; and

FIG. 14 is a state machine in accordance with another aspect of the present invention, wherein a process fails to start.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., radio-frequency (RF) devices, memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of data transmission protocols and that the system described herein is merely one exemplary application for the invention.

For the sake of brevity, conventional techniques related to signal processing, data transmission, signaling, network control, the 802.11 family of specifications, and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

In general, a wireless access port in accordance with the present invention can be set-up and configured in a manner similar to traditional access points. Without loss of generality, in the illustrated embodiment, many of the functions usually provided by a traditional access point (e.g., network management, wireless configuration, and the like) are concentrated in a corresponding wireless switch. It will be appreciated that the present invention is not so limited, and that the methods and systems described herein may be used in the context of other network architectures.

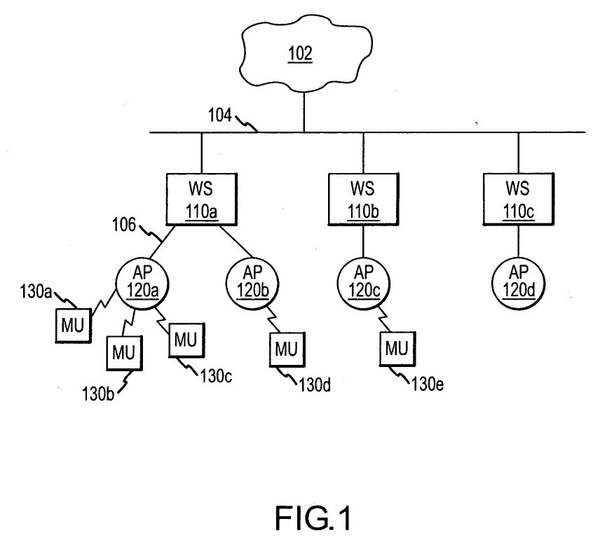

Referring to FIG. 1, one or more switching devices 110 (alternatively referred to as “wireless switches,” “WS,” or simply “switches”) are coupled to a network 104 (e.g., an Ethernet network coupled to one or more other networks or devices, indicated by network cloud 102). One or more wireless access ports 120 (alternatively referred to as “access ports” or “APs”) are configured to wirelessly connect to one or more mobile units 130 (or “MUs”). APs 120 are suitably connected to corresponding switches 110 via communication lines 106 (e.g., conventional Ethernet lines). Any number of additional and/or intervening switches, routers, servers and other network components may also be present in the system.

A particular AP 120 may have a number of associated MUs 130. For example, in the illustrated topology, MUs 130(a), 130(b), and 130(c) are associated with AP 120(a), while MU 130(e) is associated with AP 120(c). Furthermore, one or more APs 120 may be connected to a single switch 110. Thus, as illustrated, AP 120(a) and AP 120(b) are connected to WS 110(a), and AP 120(c) is connected to WS 110(b).

Each WS 110 determines the destination of packets it receives over network 104 and routes that packet to the appropriate AP 120 if the destination is an MU 130 with which the AP is associated. Each WS 110 therefore maintains a routing list of MUs 130 and their associated APs 130. These lists are generated using a suitable packet handling process as is known in the art. Thus, each AP 120 acts primarily as a conduit, sending/receiving RF transmissions via MUs 130, and sending/receiving packets via a network protocol with WS 110.

Having thus given an overview of a WLAN system useful in describing the present invention, an exemplary process monitoring system will now be described. With momentary reference to FIG. 5, a process monitor 506 communicates with one or more processes 505 through any suitable data communication method. Process monitor 506 retains a configuration file 507 relating to processes 505. Processes 505 that are in configuration file 507 are monitored for existence and health. Each monitored process 505 is expected to send periodic heartbeat messages (or simply “heartbeats”) 504 to process monitor 506. If process monitor 506 does not receive the expected heartbeats, it decides whether to take action, and what action to take.

Process monitor 506 includes any convenient combination of hardware, software, and firmware. In one embodiment, process monitor 506 comprises a software module running on a suitable operating system (e.g., Linux), and is part of a networked component such as a wireless switch 110 shown in FIG. 1. In this regard, process monitor 506 may operate on a single or dual-processor system. Similarly, processes 505 may be any type of computer process, and run on any suitable platform. In one embodiment, processes 505 are configured to run on a suitable operating system within a wireless switch 110.

Software processes 505 may operate on the same or different microprocessor as used by process monitor 506. In one embodiment, for example, software processes 505 are associated with a component accessible over the network—e.g., a switch, a router, an access point, an access port, a DHCP server, a web server, or any other network component.

Heartbeat messages 504 may be of any form and include any suitable type of information. In one embodiment, for example, a given heartbeat 504 for a process 505 is a data packet that merely includes the process ID for that process. In another embodiment, heartbeat 504 includes an indication as to whether a graceful shutdown has been initiated. In one implementation, the heartbeat includes the following information: process ID, process executable name, startup arguments and message type. Message type is one of the following: heartbeat, unregister (disconnect from process monitor), shutdown (shut the system down), restart (restart the system), start_proc (start another process), stop_proc (stop process), stop_mon (temporarily stop monitoring), resume_mon (resuming monitoring after a temporary stop).

The rate at which heartbeats are expected to be received by the process monitor is preferably configurable. In one embodiment, for example, the heartbeats may be expected at a period of 1.0 second. Any suitable time period may be used, however, depending upon CPU speed, CPU load, network speed, and the like.

In one embodiment, if process monitor 506 has not received heartbeats 504 from a process for a configurable period of time, it uses a decision tree to determine why the corresponding process 505 has not sent a heartbeat, and then decides what, if any, action it should take.

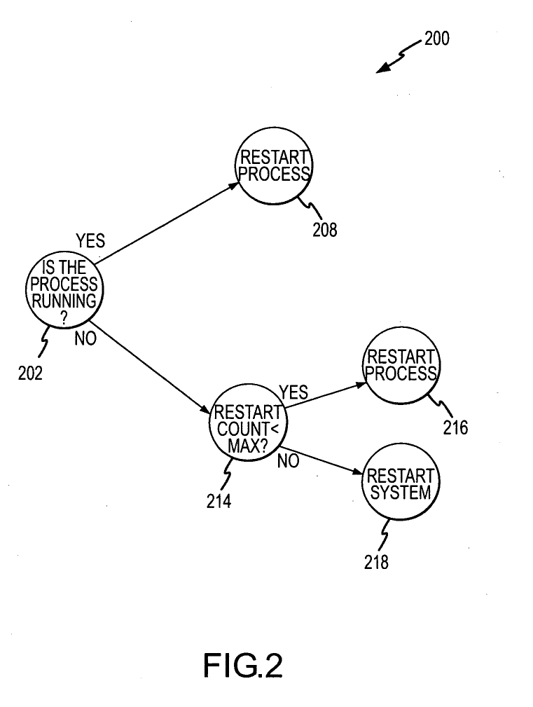

In this regard, FIG. 2 is an exemplary decision tree for a non-responsive process in accordance with the present invention. In general, at step 202, the process monitor determines whether the process is running. If so, the process is assumed to be stuck, and is restarted (step 208). If, at step 202, it was found that the process was not running, the process monitor queries whether the restart count is greater than some predetermined maximum restart number. If so, then the process is restarted (step 216). If not, then the entire system (upon which the subject process is running) is restarted (step 218).

In general, there are two reasons why a process may not send a heartbeat. First, the process may be stuck in an infinite loop. In such a case, the process's CPU time (as may be reported in the /proc/pid/stat file) has incremented since the last time the process send a heartbeat. In this first case, the process monitor attempts to restart the process. Second, the process may be blocked on a blocking system call for an extended period of time. In such a case, there may not be a reliable way to determine whether the process is blocked.

The process monitor is itself a process, and is preferably the first process to start after the system (i.e., the system upon which the process is running) has finished booting up. The process monitor can be restarted manually or as the result of a crash. In one embodiment, whenever the process monitor comes up, it checks all the processes in its configuration file to determine whether they are running. Processes that are found to be running are monitor. Processes that are found to be not running will be started and monitored.

When the process monitor receives a command to shut the system down, or when it decides to do so because a process has been restarted too many times, it will send the terminate signal (TERM) to all processes that are marked for shutdown (e.g., in a “proctab” file). When all processes have terminated, or when a timeout has occurred (e.g., a 5-second timeout), it will transfer control to the kernel, which will kill all remaining processes.

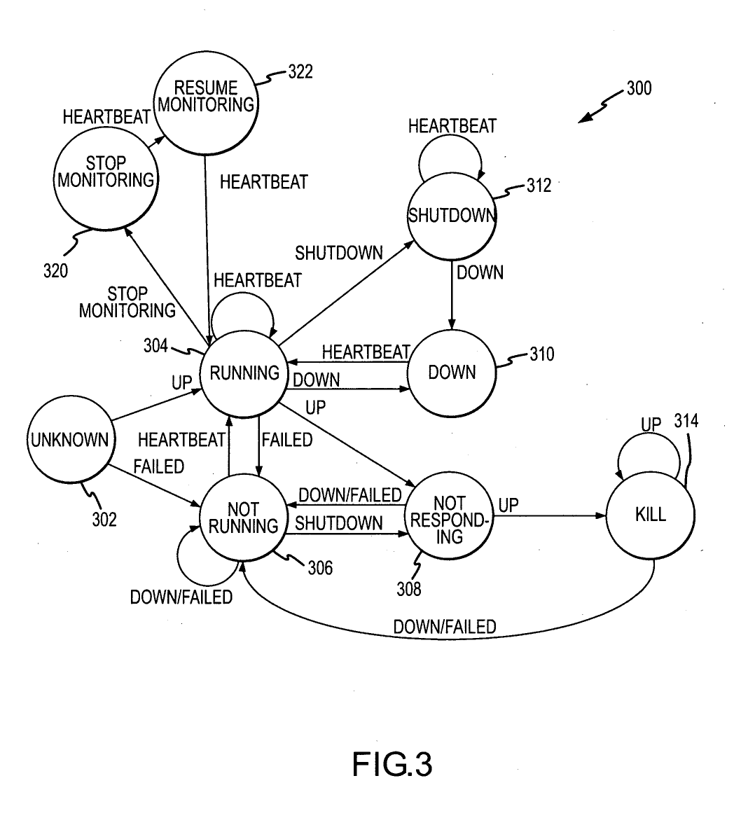

FIG. 3 is process monitoring state machine in accordance with one embodiment of the present invention. As shown, a given process begins in the unknown state 302. If the process is determined to be “up,” then it is transitioned to the “running” state 304, in which state it remains while suitable heartbeats are received by the process monitor. If the process “fails,” then the process enters the “not running” state 306. A shutdown state 312 is reached in the case a shutdown is initiated. The “down” state 310 is reached after shutdown 312 and/or after it is determined that the process goes down from “running” state 304. If a process wants to stop its monitoring temporarily (e.g., when it knowingly may be blocked by a potentially long operation), it will enter the “stop monitoring” state 320. When it wishes to resume monitoring, it will proceed to the “resume monitoring” state (322) and upon sending a heartbeat message will go again to the “running” state (304).

A “not responding” state 308 is reached from “running” state 304 or “not running” state 306 as shown, and a “kill” state 314 is reached from “not responding” state 314. Table 1 below shows the various state machine events in accordance with one embodiment of the present invention.

TABLE 1

| Event | Description | When Generated |
|---|---|---|
| Up | The process is up and | Process PID exists under /proc |
| | running | |
| Down | The process went down | Process has unregistered |
| | gracefully | |
| Failed | Process has crashed | 1. Heartbeat timeout expired |
| | | 2. /proc/<pid> does not exist |
| Heart- | The process is up and | Heartbeat was received |
| beat | running and sending | |
| | heartbeats | |
| Shut- | The system is going | A Shutdown command was issued by |
| down | down | the user or by the Process Monitor |
| | | itself because of a failed process |
| Stop | A process wants to | A Stop Monitoring request received |
| Moni- | temporarily stop | from a monitored process |
| toring | its monitoring | |
| Resume | A process wants to | A Resume Monitoring request |
| Moni- | resume monitoring | received from non-monitored process |
| toring | after monitoring | |
| | has been stopped | |
| | temporarily | |

Similarly, Table 2 shows various processor monitor states and corresponding actions in accordance with one embodiment of the invention.

TABLE 2

| State | Description | Actions |
|---|---|---|
| Unknown | Process Monitor has started and | Check process state |
| | does not know whether the | |
| | process is running | |
| Running | The process is running | Start heartbeat timeout |
| | | count |
| Not | The process is not running | Start the process |
| Running | | |
| Not | The process has not sent | Send the process the |
| Responding | heartbeats | terminate signal |
| Kill | The process is still up after | Send kill signal to |
| | being sent the terminate signal | process |
| Down | The process went down gracefully | Wait for a heartbeat |
| | | from the process when |
| | | it comes back up |
| Shutdown | The process is being killed | Send kill signal to |
| | because of system shutdown | process |
| Stop | A process wants to temporarily | Stop waiting for |
| Monitoring | stop its monitoring | heartbeats and ignore |
| | | incoming hearbeats |
| Resume | A process wants to resume | Start heartbeat timeout |
| Monitoring | monitoring after monitoring | count |
| | has been temporarily stopped | |

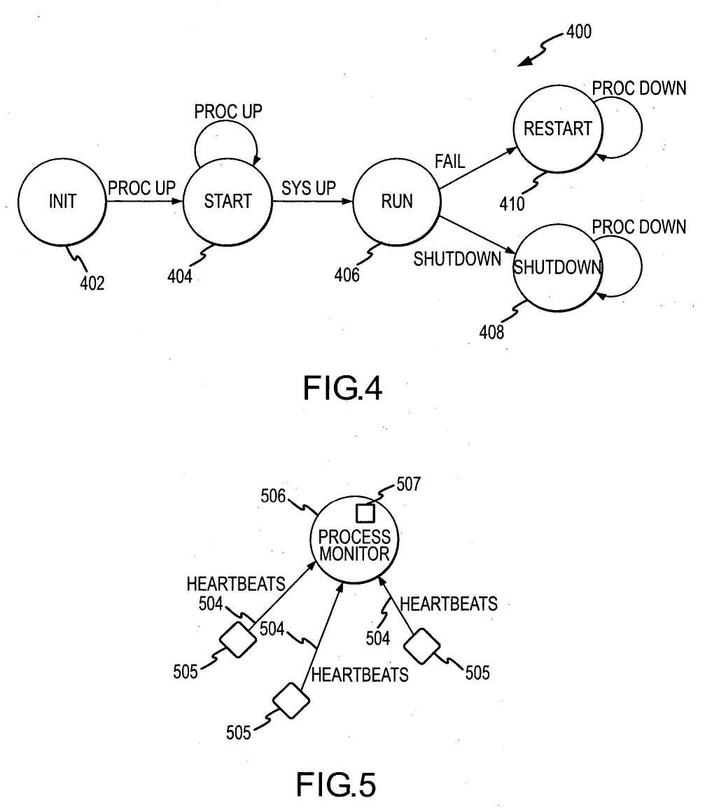

At a higher level of abstraction, the process monitor maintains a state machine for the entire system. FIG. 4 depicts a system monitoring state machine in accordance with one embodiment of the present invention. In general, the state machine has an “initial” state 402, a “start” state 404, a “run” state 406, a “restart” state 410, and a “shutdown” state 408. In this regard, Table 3 below includes system monitoring events in accordance with one embodiment of the invention.

TABLE 3

| Event | Description | When Generated |
|---|---|---|
| Proc | A process is up and | Received the first heartbeat from a |
| Up | running | processes |
| Proc | A process went down | Process has unregistered or heartbeat |
| Down | | timeout |
| Sys Up | All processes are up | Last process in proctab is up |
| Fail | Process failure that | A processes has been restarted up to |
| | requires system restart | the maximum no. of times |
| Shut- | The system should go | A Shutdown command was issued by |
| down | down | the user |

Similarly, Table 4 below lists system monitoring state machine states and actions in accordance with the illustrated embodiment.

TABLE 4

| State | Description | Actions |
|---|---|---|
| Init | Initial state | Read process information |
| | | from the proctab file and |
| | | initialize resources |
| Starting | Process Monitor is starting | Start all processes from the |
| | all processes | proctab file |
| Running | All processes are up and | |
| | running | |
| Restart | System is restarting | Kill all processes and restart |
| | | the system |
| Shutdown | System is shutting down | Kill all processes and shut |
| | | down the system |

The configuration file 507 shown in FIG. 5 includes a list of processes to be monitored. In one embodiment, for example, a file named “/etc/proctab” is used for this purpose, and each entry in the configuration file has the format:

executable: arguments: action: wait: max_restarts: shutdown

The executable field specifies the process's executable file, and the arguments field includes any arguments sent to the executable file (optional). The action field specifies how to monitor the process. For example, if action=“monitor,” the process will be restarted, then monitored. Whenever it terminates or stops to respond, it will be restarted up to max-restarts times. If action=“start,” the process will be started, but not monitored.

The wait field is set to “wait” to specify that the monitor should wait for a heartbeat from the current process before starting the rest of the processes listed in the configuration file. If “nowait” is specified, the monitor does not wait, and continues starting the listed processes.

The max_restarts field specifies the maximum number of times a process can be restarted. After this number is reached, the monitor restarts the entire system. In one embodiment, a value of “−1” in this field specifies that there is not limit to restarts. The shutdown field is set to “shutdown” if the process is to be killed when the system shuts down, or “noshutdown” if the system is not be killed.

In one embodiment, a hardware watchdog is coupled to the process monitor, and will be initialized and periodically reset by the process monitor. If the process monitor itself becomes for any reason, the whole system is restarted by the hardware watchdog.

Some processes may not be started by the process monitor directly, but may be started by one of the monitored processes initiated by the process monitor. Such a process might include, for example, a network daemon that subsequently starts a DHCP daemon. Typically, the process monitor will not monitor this indirectly-started process. However, in accordance with another aspect of the invention, these processes may be monitored by dynamically registering the process with the process monitor. When the process monitor receives a dynamic registration request, it adds the process to the monitored process list. In such a case, however, the process monitor will not have information regarding how many times to restart the process, so a configurable default value is preferably used.

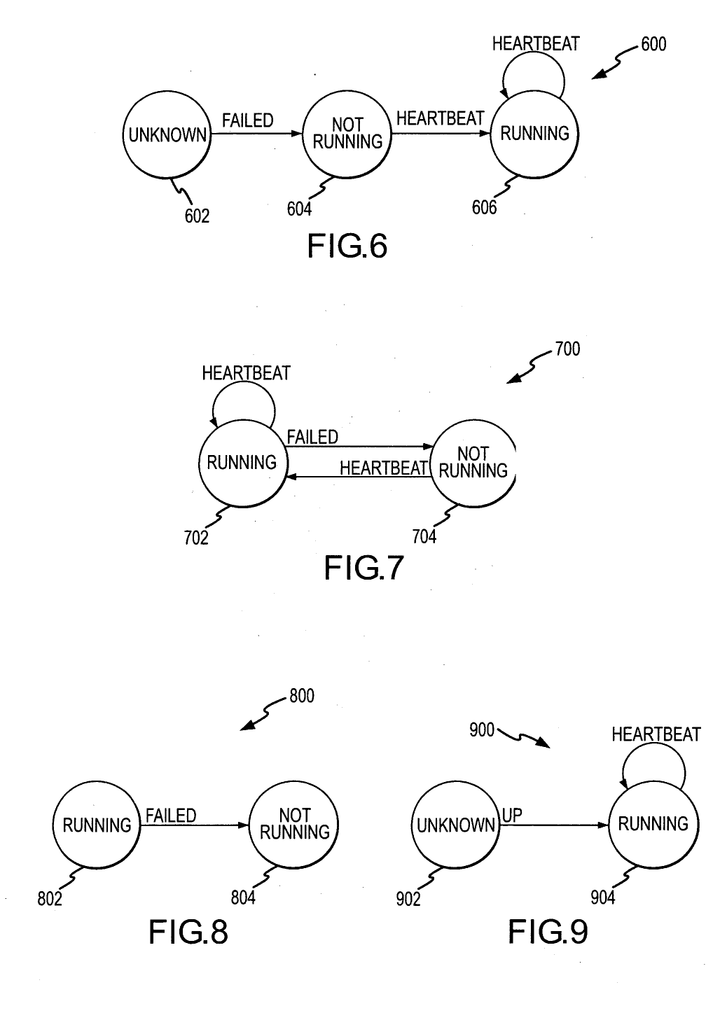

FIG. 6 is a state machine in accordance with another aspect of the present invention, depicting a normal process startup use case. In this use case, the process is initially in an unknown state 602. When the system notices that the PID for the process does not exist under/proc, it starts up the process. In this way, the process transitions from the “not running state” 604 to the “running” state 606 when a heartbeat event occurs. The process maintains the “running state” 606 as long as a suitable heartbeat message is received.

FIG. 7 is a state machine in accordance with another aspect of the present invention, depicting a process crash use case. The process begins in the “running” state 702. When the process stops sending a heartbeat, the process monitor check to determine whether its process ID (PID) exists under/proc. If the process has crashed, it will not exist. The process monitor changes the state to “not running” (704). If the restart count has not reached the maximum number of allowed restarts, the process monitor starts the process up again, whereupon it sends a suitable heartbeat and transitions to the “running state.”

FIG. 8 is a state machine in accordance with another aspect of the present invention, depicting a use case involving a process with greater than the maximum allowable number of restarts. The process starts in the “running” state 802. When it fails, it enters the “not running” state 804. When the process stops sending heartbeats, the process monitor determines whether the PID exists. The process monitor changes the process state to “not running” and checks its restart counter. When it has reached the maximum number of allowed restarts, the system is rebooted.

FIG. 9 is a state machine in accordance with another aspect of the present invention, depicting a use case involving the process monitor starting after a crash. The process starts in the unknown state 902. When the process monitor determines that the process is “up” (i.e., its PID exists under/proc), it changes the state to “running” 904. The heartbeat timer is started and the process monitor waits for a heartbeat from the process.

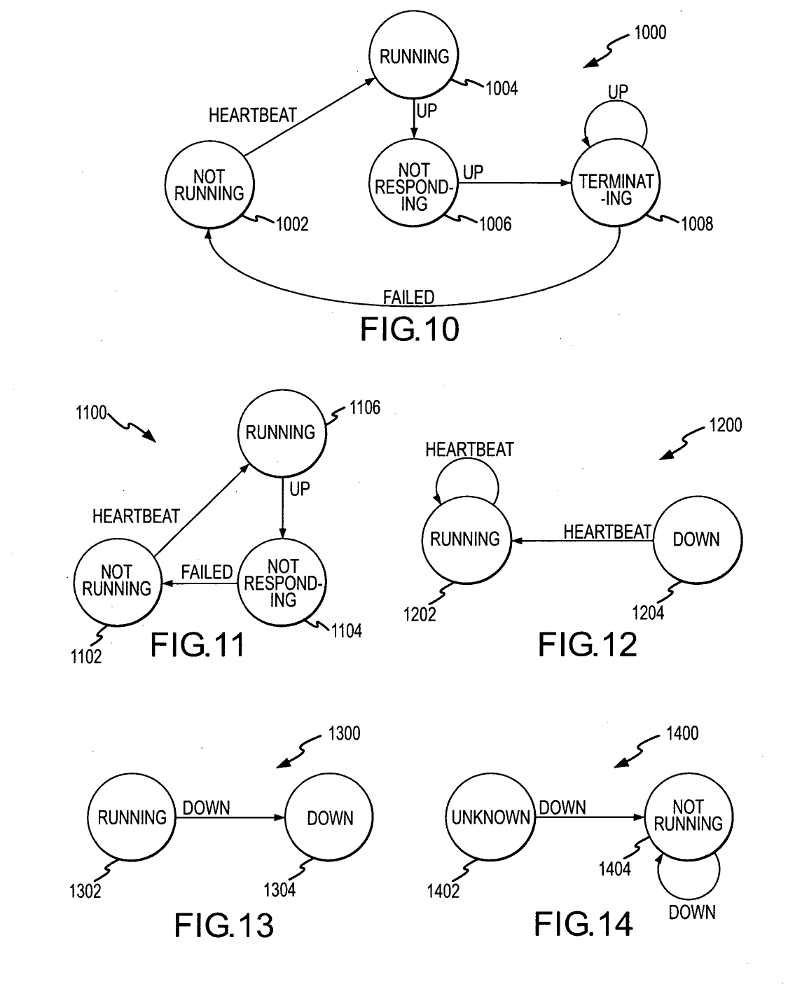

FIG. 10 is a state machine in accordance with another aspect of the present invention, depicting a use case involving a process that is stuck and not responding. The process begins in the “running state” 1004. The process monitor determines that the process is not responding (1006), but is still “up.” The process monitor issues a terminate signal and waits for termination (state 1008). After the termination time-out has expired, and the process is still running, the process monitor issues the kill signal. After the termination timeout has expired the process enters the “not running” state 1002. The process monitor restarts the process, whereby it begins sending a heartbeat, and then transitions back to the “running” state 1004.

FIG. 11 is a state machine in accordance with another aspect of the present invention, depicting a use case wherein a process is stuck. A process begins in the “running” state 1106. It is still “up” but stops sending heartbeats, and thus enters the “not responding” state 1104. After the termination timeout has expired, the process is no longer running, at which time the process monitor transitions the process to the “not running” state 1102. The process monitor restarts the process, and when a heartbeat is received, transitions it back to the “running” state 1106.

FIG. 12 is a state machine in accordance with another aspect of the present invention, depicting a use case wherein a stopped process is restarted. In particular, the process begins in the “down” state 1204. Once a heartbeat is received, the process is considered in the “running” state 1202.

FIG. 13 is a state machine in accordance with another aspect of the present invention, depicting a use case wherein a process exits gracefully. That is, when the process calls a suitable request for graceful process exit (e.g., a pmUnsubscribe), a special heartbeat message indicates that the process is going down. The process monitor changes the state from “running” 1302 to “down” 1304 and waits for the process to come back up and send a heartbeat.

FIG. 14 is a state machine in accordance with another aspect of the present invention, wherein a process fails to start. In particular, the process begins in the “unknown” state 1402. When the heartbeat timer expires for the process, and the process has not sent a heartbeat, the process monitor changes its state to “not running.” The process is then restarted until it reaches a maximum number of restarts or until it sends a heartbeat.

In one embodiment, certain serviceability data is retained—e.g., statistics and state history. Suitable statistics might include, for each monitored process, the number of times a process is restarted, number of heartbeats received from the process, maximum delay between two consecutive heartbeats, and the last time a heartbeat was received from the process. State history might include, for each process, a record of each state change, the time that the change occurred, and the events that caused the change. It will be appreciated that other serviceability data of this nature may also be stored, and that this list is not meant to be comprehensive.

It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A software monitoring system comprising:
a software process having a state, said software process configured to produce a heartbeat message;
a process monitor communicatively coupled with said software process, said process monitor configured to receive said heartbeat message and change said state of said software process in accordance with whether said heartbeat message is received within a predetermined time period.

2. The system of claim 1, wherein said state of said software process is one of “unknown,” “running,” “not running,” “not responding,” “kill,” “down,” “shutdown,” “stop monitoring,” and “resume monitoring.”

3. The system of claim 1, wherein said process monitor further comprises a configuration file including an entry associated with said software process.

4. The system of claim 1, wherein said process monitor further comprises a file including an entry associated with processor time utilized by said software process.

5. The system of claim 1, wherein said heartbeat message includes a process identification (PID) associated with said software process.

6. The system of claim 5, wherein said heartbeat message further includes an indication that a graceful shutdown has been initiated.

7. The system of claim 1, wherein said predetermined time period is between approximately 0.5 seconds and 3.0 seconds.

8. The system of claim 1, further including a hardware watchdog communicating with said process monitor.

9. A method of monitoring a software process, said method including:
configuring said software processes to produce a periodic heartbeat message;
receiving, in a process monitor communicatively coupled with said software process, said heartbeat message
changing a state of said software process in accordance with whether said heartbeat message is received within a predetermined time period.

10. The method of claim 9, wherein said state of said software process is one of “unknown,” “running,” “not running,” “not responding,” “kill,” “down,” “shutdown,” “stop monitoring,” and “resume monitoring.”

11. The system of claim 9, further including the step of reading a configuration file including an entry associated with said software process.

12. The system of claim 9, further including the step of reading a file including an entry associated with processor time utilized by said software process.

13. A network switch comprising:
a plurality of software processes having respective states, each of said software process configured to produce a heartbeat message;
a process monitor communicatively coupled with said software process, said process monitor configured to receive said heartbeat message and change said state of said software process in accordance with whether said heartbeat message is received within a predetermined time period.

14. The network switch of claim 13, wherein said heartbeat message includes a process identification (PID) associated with said software process.

15. The network switch of claim 13, wherein said network switch includes a processor, a memory, and an operating system configured to operate in conjunction with said processor, and wherein said process monitor is configured to run on said operating system.

16. The network switch of claim 13, wherein said process monitor is configured to determine whether said state of said software module corresponds to an infinite loop.

17. The network switch of claim 13, wherein said process monitor is configured to determine whether said state of said software module corresponds to “not-running.”

18. The network switch of claim 13, wherein said heartbeat is transmitted via a packet-switched network.
